(19) United States
(12) Patent Application Publication
(10) Pub. No.: US 2026/0367680 A1
(43) Pub. Date: Nov. 19, 2026

(54) Method and Device for Determining a Thermal Load on a Component in a Technical System and for Predictively Diagnosing Thermal Fatigue of This Component

(71) Applicant: Bayerische Motoren Werke Aktiengesellschaft, Muenchen (DE)

(72) Inventor: Lukas FREYTAG, Muenchen (DE)

(21) Appl. No.: 19/130,161

(22) PCT Filed: Dec. 7, 2023
(86) PCT No.: PCT/EP2023/084809

§ 371 Date: May 15, 2025

(30) Foreign Application Priority Data
Dec. 16, 2022 (DE) 10 2022 133 734.0

(51) Int. Cl. G06F 1/20

(52) U.S. Cl. CPC G06F 1/20

(57) ABSTRACT

Methods for determining a thermal load on a passive component of a technical system, the technical system including the passive component and at least one active component generating heat during operation of the technical system, are provided herein. Thermal load monitors for the technical systems are further provided. Vehicles including the thermal load monitors are further provided.

### BACKGROUND AND SUMMARY

The present disclosure relates to technical systems having several components and a method for monitoring a thermal load on several components.

Technical systems such as vehicles or the like, can be operated in a variety of ways with different loads. Active components, such as engines, heating devices and suchlike, can generate waste heat which, depending on the thermal coupling, also heats up passive components.

However, higher temperatures generally place a thermal load on all components of the technical system. The degree of ageing depends considerably on the level of thermal stress and the duration of time. In addition, damage to the component in question can occur if a critical maximum temperature is exceeded.

As a rule, the temperature of a component of the technical system can be detected and monitored using temperature sensors. However, temperature sensors are complex and cannot be installed for each of the components in a technical system for cost reasons or due to the installation effort required. In addition, temperature sensors themselves can be susceptible to errors and can fail, in particular when exposed to environmental influences such as moisture or dirt. Therefore, in particular for passive components for which no dedicated temperature monitoring using a temperature sensor is provided, the thermal load cannot be determined, so that the effects of the thermal load over a longer time period can only be noticed after functional impairment or failure of the component in question.

The object of the present disclosure is to determine the load case of a component based upon a thermal effect, without having to provide a temperature sensor on the component in question.

This task is solved by the method for determining a thermal load on a component in a technical system according to the present disclosure as well as a method for training a data-based temperature model and a corresponding device according to the present disclosure.

Further embodiments are indicated in the present disclosure.

According to a first aspect, a method for determining a thermal load on a component in a technical system having at least one active component which generates waste heat during its operation and at least one passive component, said method comprising the following steps:
Continuously acquiring operating variables and environmental variables as operating variable and environmental variable profiles in successive evaluation time windows;
Evaluating the operating variables and environmental variable profiles in an evaluation time window to obtain input data;
Determining a temperature indication using a data-based temperature model in each of the successive evaluation time windows, wherein the data-based temperature model is trained to assign input data to a temperature indication for a temperature of the at least one passive component.

A technical system, such as a vehicle, usually comprises active components which, depending on the load, generate waste heat during operation, which is released into the environment and to other neighboring active and passive components of the technical system. The heating of the other components leads to a thermal load there, which accelerates their degradation or thermal ageing in the sense of thermal fatigue.

As a rule, a load case of the components due to a thermal effect is not measurable, but only becomes apparent through a functional impairment or total failure of the component concerned after a longer time period.

The above method proposes to use a data-based temperature model to determine a temperature of a specific component in the technical system based on operating variables of the technical system that influence its load case and environmental variables. In particular, the operating variables can indicate the load cases of active components, such as speed, torque, engine power, and the like in the case of combustion engines or a current and/or a power in the case of electronic components; so that current-carrying components can also be detected as a heat source (for example, traction cable, power electronics or battery in the electric vehicle). An environmental variable can indicate for example, an ambient temperature, a measurement of sunlight, a humidity level, weather conditions, such as rain, and the like.

It may be provided that evaluating the operating variable and environmental variable profiles involves selecting a value of the respective operating variable and environmental variable at a point in time within the operating variable and environmental variable profiles in the evaluation time window and/or determining at least one characteristic variable derived from the operating variable profiles and environmental variable profiles within the evaluation time window as an aggregated and/or statistical characteristic, in particular a mean value or a median value.

The data-based temperature model assigns a corresponding current temperature of the relevant component to time series of these input variables. For example, the data-based temperature model can be designed as a neural network, an LSTM (Long short-term memory), a GRU (Gated Recurrent Unit) or the like.

Furthermore, the data-based temperature model can correspond to a CNN-LS TM model or a CNN-GRU model.

To map the time series of the input variables to a temperature indication, the data-based temperature model can be based on a convolutional neural network (CNN) in conjunction with the LSTM architecture. Here, the operating variables and environmental variables are provided as time series in time intervals and summarized in a matrix. This matrix is evaluated in consecutive time intervals using a CNN for the feature extraction and the extracted features are continuously evaluated in each time interval using the LSTM architecture to determine a temperature indication at each evaluation time.

Furthermore, the temperature indication can correspond to a temperature or an indication of a temperature range, wherein in the case of a temperature, temperature indication is assigned in a temperature range, wherein for each temperature range a frequency is indicated with which the temperature has been within the temperature range for an evaluation time window since commissioning of the at least one passive component, whereby the warning regarding the thermal load of the at least one passive component is signaled depending on the frequency in each of the temperature ranges.

The time series of temperature data determined in this way represents a temperature profile to which the component in question is exposed. A temperature load collective is derived from the temperature profile, in other words, a frequency distribution is determined, for example, which cumulatively determines the frequencies of temperatures above a certain temperature limit in each case. The temperature ranges defined by the temperature limits overlap accordingly. The temperature load spectra are accumulated over the entire operating time of the relevant component and evaluated accordingly.

The temperature load collectives can be evaluated according to the frequency with which the resulting temperature information is assigned to a specific temperature range, which is defined by the respective temperature limit. If a predefined frequency threshold is exceeded in a specific temperature range, this can be noted in a fault memory of the vehicle for the component in question. Depending on the safety relevance of the component, a corresponding warning can be signaled to a user of the technical system or the component can continue to be operated in an emergency mode or the continued operation of the technical system can be blocked.

To train the data-based temperature model, time series of operating variables can be recorded during the operation of the technical system using the resulting temperature of the component. The temperature of the component can be determined, for example, by a temperature sensor installed for testing purposes on the component in question. Training is carried out using a method known for machine learning models, such as backpropagation and the like, using provided training data sets.

The input data for the data-based temperature model can correspond to the time series of the operating variables and environmental variables for successive evaluation times. The operating variables and environmental variables at the evaluation time can correspond to their values at the beginning or end of an evaluation time window assigned to the evaluation time, of, for example, a duration of 1-5 seconds, or derived variables, which are derived from the course of the operating variables and environmental variables during the evaluation time window as statistical or aggregated variables (characteristics), such as an average value of the course of the operating variables and/or environmental variables. A training data set then corresponds to a vector of the operating variables and environmental variables and/or variables derived from them (within the evaluation time window) as well as the assigned temperature indication as a label. The training can be carried out with training data sets and monitored or checked with validation data sets (selected as part of the training data sets).

The data-based temperature model can be trained externally to the technical system. After training, the data-based temperature model can be transferred to the technical system for monitoring the thermal load on the component.

According to a further aspect, a method for training a data-based temperature model for use with the above method, comprising the steps of:
Continuously acquiring operating variables and environmental variables as operating variable and environmental variable profiles in successive evaluation time windows and determining a related temperature indication on a passive component;
Generating training data sets depending on the operating and environmental variable profiles and the related temperature data;
Training the data-based temperature model to assign input data corresponding to or dependent on the operating variable and environmental variable profiles to a temperature indication for a temperature of the at least one passive component;
Model parameters of the data-based temperature model can also be transmitted to a control unit of the system.

Embodiments are explained in greater detail below, with reference to the accompanying drawings. They show:

### BRIEF DESCRIPTION OF THE DRAWINGS

FIG. 1 illustrates a technical system with several components, the thermal load of which is to be monitored;

FIG. 2 illustrates a flow chart for illustrating a method for monitoring a component in the technical system;

FIG. 3 illustrates a schematic representation of the data-based temperature model;

FIG. 4 illustrates a diagram for displaying the temperature load spectra over the entire operating time of a component;

FIG. 5 illustrates a plot of temperature over accumulated operating hours; and

FIG. 6 illustrates a flowchart illustrating a method for training the data-based temperature model.

### DETAILED DESCRIPTION OF THE DRAWINGS

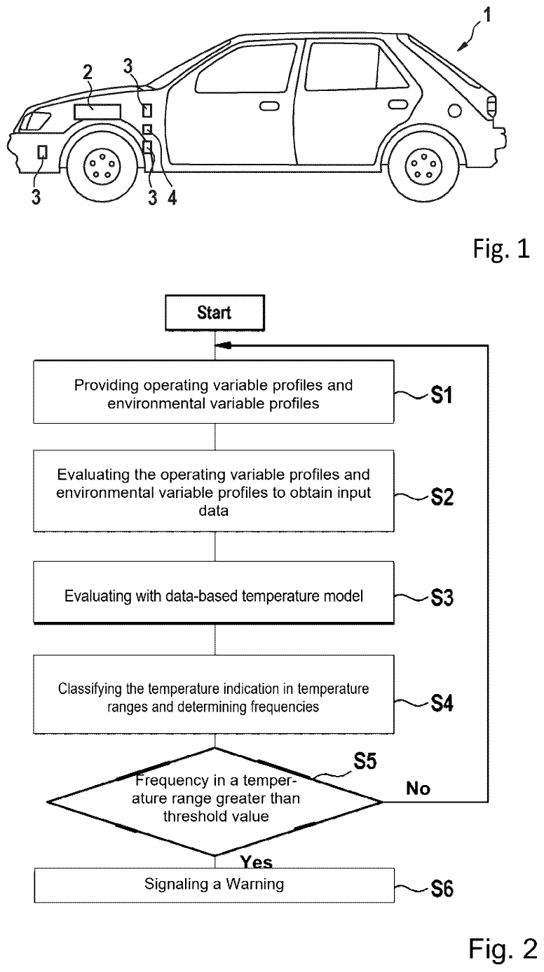

FIG. 1 shows a schematic representation of a vehicle as an example of a technical system. The vehicle 1 comprises a plurality of components, wherein an engine is arranged as an active component 2 and a plurality of passive components 3 are arranged in the proximity of the engine. The passive components may comprise, for example, a transmission, an alternator, an ECU module, a windscreen wiper system, a heating system, steering components, or the like.

For example, one of the components may contain a plastic whose degradation depends on the duration and level of a thermal load.

Thermal energy is fed into the system via the engine 2. The amount of thermal energy is determined by the efficiency of the engine, which depends significantly on the operating mode and type of engine. The operating mode of the engine can be determined, for example, by the speed, torque, engine power, vehicle speed, cooling capacity of an engine radiator, engine temperature, and the like.

Furthermore, the temperature distribution in the vehicle in respect of the temperature effect on the passive components 3 is significantly dependent on ambient conditions, which can be influenced, for example, by the outside temperature, solar radiation, wind speed, driving speed, and the like.

A data-based temperature model is implemented in a control unit 4 of the vehicle 1, which can be designed to control many vehicle functions, which monitors a temperature of one or more of the passive components 3 as a virtual sensor to estimate the thermal load of the passive components 3. For this purpose, a method is implemented as an algorithm in the control unit 4, as illustrated in more detail in the flow diagram in FIG. 2.

In Step SI, operating variables and environmental variables are recorded as operating variable and environmental variable profiles, preferably at regular time intervals of, for example, between 0.1 s and 1 s. The operating variables of the operating variable profiles can include, for example, the rotational speed, the load on the engine, the engine power, the speed of the vehicle and the like. The environmental variables can include outside temperature, solar radiation, wind speed, and humidity.

In Step S2, the operating variable profiles and environmental variable profiles within an evaluation time window of, for example, 1 s to 10 s are evaluated as input data for a time step. The duration of the evaluation time window can also be provided as a parameterizable hyperparameter, which is optimized during training. To this end, the input data can comprise a value of each of the operating variables and environmental variables, for example a corresponding value at the beginning or end of the corresponding evaluation time window, and/or aggregated characteristic variables derived therefrom. The characteristic variables can be derived from the operating variable profiles and environmental variable profiles within the evaluation time window as aggregated and/or statistical characteristics, such as a mean value, a median or the like.

The input data can be provided in the form of a vector or a matrix and serve as input data for a data-based temperature model.

The input data characterizes the operation of the technical system during the evaluation time window at a specific evaluation time.

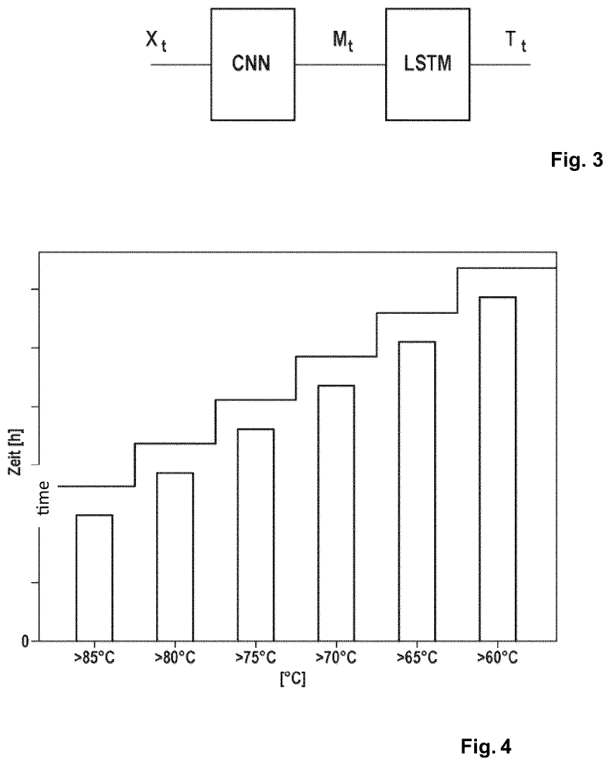

In step S3, the input data is now fed to the data-based temperature model at each evaluation time, which is trained to assign such input data to a temperature indication for a specific component. The temperature model preferably has a CNN-LSTW architecture, as shown in FIG. 3, for example.

FIG. 3 shows a block diagram of a data-based temperature model 10 with a CNN block 11 comprising a convolutional neural network to recognize patterns or features from the input data. The CNN block 11 provides input data features Mt. These input data features Mt are fed to an LSTM block 12 (LSTM: Long Short Term Memory), which processes the input data features Mt to obtain a temperature value Tt at each evaluation time t. The LS TM block 12 makes it possible to model dynamic processes so that past operating states of the technical system (vehicle 1) can be considered when modeling the current temperature indication.

The temperature information determined at each evaluation time is either output immediately classified into temperature ranges by the data-based temperature model 10 or assigned to temperature ranges in the optional Step S4 after each evaluation time. The frequencies since commissioning of the relevant component are cumulated for each temperature range. The temperature ranges are defined as overlapping ranges of temperatures each above a indicated temperature limit. For example, temperature ranges can be defined as so-called temperature load collectives, such as temperature ranges of over 60 °C, over 65 °C, over 70 °C, over 75 °C, over 80 °C, and over 85 °C, to which the corresponding temperature indication is assigned after each evaluation time. The result is a diagram as shown in FIG. 4, for example. Each temperature value to be evaluated can therefore be assigned to one or more temperature ranges and thus increase the frequency in one or more temperature ranges.

The heights of the temperature load collectives in the diagram indicate the frequencies of detection or the total duration since commissioning during which the component has a temperature in the corresponding temperature range. The total duration can be calculated, for example, by multiplying the frequency by the duration of an evaluation time window. The stepped threshold indicates the limit value of the accumulated operating time above the respective temperature limit.

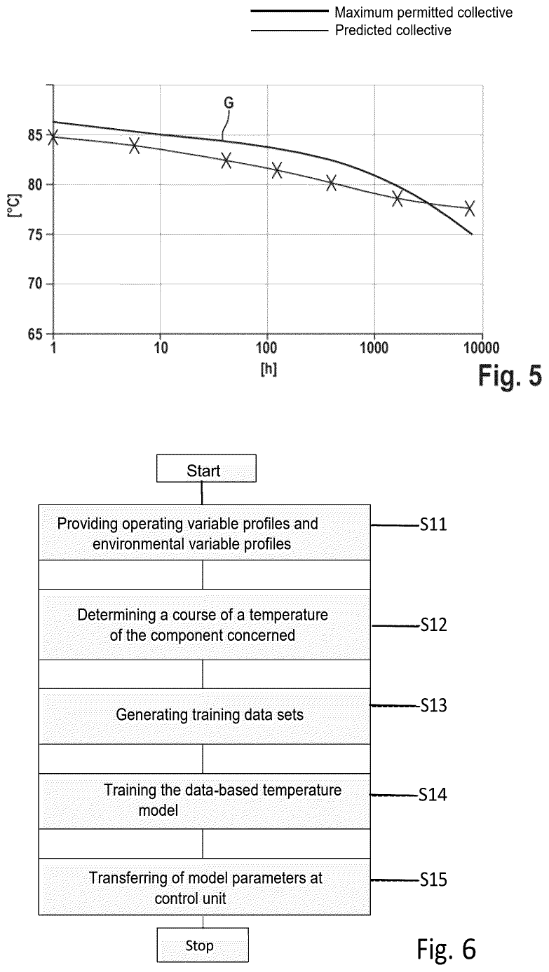

FIG. 5 shows an alternative representation in which the temperature is plotted over the accumulated operating hours. The points shown as crosses indicate the frequencies with which the respective temperature limit has been exceeded. The bold line G indicates the corresponding limit values of the accumulated operating time above the respective temperature limit. If the frequency or total operating time at a temperature exceeds the corresponding temperature limit at one point, then the thermal fatigue of the component is assumed. The increment of the temperature support points (here: 5 °C) can be selected as desired.

In Step S5, a check is made to determine whether a frequency of one of the temperature load spectra exceeds a predefined frequency threshold value for one of the temperature limits in question. If this is the case (Alternative. Yes), a corresponding warning can be signaled in Step S6. For example, in the case of a vehicle, the warning as a technical system may include issuing a notice to visit a workshop or to describe a fault memory, so that the component can be examined or replaced during a subsequent visit to a workshop. An emergency operating mode can also be activated. If it is determined in Step S5 that the frequency of one of the temperature load spectra does not exceed a predefined frequency threshold value (alternative: No), the method is continued with Step S1.

FIG. 6 shows a flow chart illustrating a method for training the data-based temperature model. For this purpose, in Step SI 1 the components of interest are provided with a temperature sensor in a vehicle, and the vehicle is operated in real operation. In said step, operating variable profiles and environmental variable profiles are acquired.

At the same time, in Step S 12, the resulting temperature of the component concerned as acquired.

In Step S13, input data for successive evaluation time windows are determined from the operating variable profiles and environmental variable profiles and the temperature of the relevant component is assigned to the input data for each evaluation time window, for example, to the input data for each evaluation time window. The input data can be determined as described above from the operating variable profiles and environmental variable profiles in a corresponding evaluation time window. These data represent training data sets. Furthermore, validation data sets can be generated in the same way, with which the trained model can later be checked or with which the training process can be controlled.

In Step S14, the data-based temperature model is trained in a known manner using the training data sets. The training is preferably carried out outside of the vehicle in a cloud using known methods, such as backpropagation, for example, and results in model parameters that characterize the relevant temperature model of the proposed architecture.

In Step SI 5, the model parameters are transmitted from the cloud to the control unit 4 in the vehicle 1, so that a corresponding analysis, as described above, can be carried out there.

### LIST OF REFERENCE SIGNS

1 Vehicle
2 Active component
3 Passive component
4 Control device

1-10. (canceled)

11. A method for determining a thermal load on a passive component of a technical system, the technical system comprising the passive component and at least one active component generating heat during operation of the technical system, the method comprising:
continuously acquiring operating variables and environmental variables as operating variable profiles and environmental variable profiles in successive evaluation time windows;
determining a temperature indication using a data-based temperature model in each of the successive evaluation time windows depending on a corresponding profile of the operating variable profiles and the environmental variable profiles, wherein the data-based temperature model is trained to assign input data corresponding to, or depending on, the operating variable profiles and the environmental variable profiles to a temperature indication for a temperature of the passive component; and
signaling a warning regarding the thermal load of the passive component depending on the temperature indication.

12. The method according to claim 11, wherein an operating variable of the operating variable profiles comprises a rotational speed of an engine as an active component, a load of an engine and an engine power, a current, and/or a power of an electric component; and
wherein an environmental variable comprises one or more of an outdoor temperature, solar radiation, wind speed, and humidity.

13. The method according to claim 11, wherein the operating variable profiles and the environmental variable profiles are evaluated to obtain input data;
wherein the input data comprises a value of an operating variable and an environmental variable at a point in time within the operating variable profiles and the environmental variable profiles in the evaluation time window and/or at least one characteristic variable derived from the operating variable profiles and the environmental variable profiles within the evaluation time window as an aggregated characteristic and/or a statistical characteristic.

14. The method according to claim 13, wherein the aggregated characteristic and/or the statistical characteristic is a mean value or a median value.

15. The method according to claim 11, wherein the data-based temperature model is a CNN-LSTM model or a CNN-GRU model.

16. The method according to claim 11, wherein the temperature indication corresponds to a temperature;
wherein the temperature indication is assigned to a temperature range that is indicated by a lower temperature limit;
wherein for each temperature range a frequency is indicated with which the temperature has been within the temperature range for an evaluation time window since commissioning of the at least one passive component; and
wherein the warning is signaled depending on the frequency in each of the temperature ranges.

17. The method according to claim 11, wherein the temperature indication corresponds to an indication of a temperature range;
wherein the temperature range is indicated by a lower temperature limit;
wherein a frequency of the determination of the indications of the temperature range for the evaluation time windows is determined for each temperature range; and
wherein the warning is signaled depending on the frequence in each of the temperature ranges.

18. The method according to claim 11, wherein the data-based temperature model is trained externally of the technical system and model parameters of the data-based temperature model are transferred to the technical system after training is completed.

19. A method for training the data-based temperature model for use with the method according to claim 11, the method for training the data-based temperature model comprising:
continuously acquiring operating variables and environmental variables as operating variable profiles and environmental variable profiles in successive evaluation time windows and determining a related temperature indication of the passive component;
generating training data sets depending on the operating variable profiles and the environmental variable profiles and related training temperature indications; and
training the data-based temperature model to assign input data corresponding to, or depending on, the operating variable profiles and the environmental variable profiles to the temperature indication for the temperature of the passive component.

20. The method according to claim 19, wherein model parameters of the data-based temperature model are transferred to a control device of the technical system.

21. A thermal load monitor for a technical system comprising a passive component and at least one active component that generates heat during operation of the technical system.

22. A vehicle comprising the thermal load monitor according to claim 21.
